(19) United States
(12) Patent Application Publication
(10) Pub. No.: US 2024/0169698 A1
(43) Pub. Date: May 23, 2024

(54) OBJECT DETECTION USING ARTIFICIAL INTELLIGENCE

(71) Applicant: Logitech Europe S.A., Lausanne (CH)

(72) Inventors: Anurag BANSAL, Portland, OR (US); Oleg OSTAP, Camas, WA (US); Miguel Angel MAESTRE TRUEBA, Portland, OR (US); Kristopher Glenn PERRY, Camas, WA (US)

(21) Appl. No.: 17/993,710

(22) Filed: Nov. 23, 2022

(51) Int. Cl. G06V 10/774; G06V 10/82; G06V 40/10

(52) U.S. Cl. CPC G06V 10/774; G06V 10/82; G06V 40/10

(57) ABSTRACT

A method of training a machine learning model includes training a primary part of a composite neural network to identify a primary segment of objects in a training image, freezing the primary part of the composite neural network after training the primary part of the composite neural network, and after freezing the primary part of the composite neural network, training, using activations of the primary part of the composite neural network, a secondary part of the composite neural network to identify a first subsegment of objects or a feature of the first subsegment of objects in the training image. The first subsegment of objects is a subset of the primary segment of objects.

### FIELD

The present disclosure is generally directed to the training of machine learning models. More specifically, embodiments relate to various processes for training a machine learning model to recognize a primary segment of objects (e.g., in an image) and a subsegment of objects within the primary segment of objects.

### DESCRIPTION OF THE RELATED ART

In recent years, video-conferencing and other video related activities have seen a dramatic shift in popularity, thanks largely to the proliferation of high-speed Internet, declining costs of video-conferencing and video streaming equipment, and a global need for remote collaboration. User expectations have increased along with the popularity of video-conferencing and live streaming with increased demand for sophisticated video delivering systems. Users have come to expect the same sophisticated technology to be available in easily installed systems having the flexibility to be used across video-conference and live streaming environments of all different sizes and shapes. Automatic framing and detection of objects within a conference environment provides an example of one such technology.

Machine learning may be used to detect or recognize objects that appear within images or videos. For example, a machine learning model (e.g., a neural network) may be trained to analyze frames of a video to detect people that appear in the video. These detections may then be used to monitor the number of people in the video and their respective locations.

### SUMMARY

According to an embodiment, a method of training a machine learning model includes training a primary part of a composite neural network to identify a primary segment of objects in a training image, freezing the primary part of the composite neural network after training the primary part of the composite neural network, and after freezing the primary part of the composite neural network, training, using activations of the primary part of the composite neural network, a secondary part of the composite neural network to identify a first subsegment of objects or a feature of the first subsegment of objects in the training image. The first subsegment of objects is a subset of the primary segment of objects.

The primary segment of objects may include portions of objects appearing in the training image. The first subsegment of objects may include sub-portions of the portions of the objects appearing in the training image. The primary segment of objects may include upper bodies of people appearing in the training image. The first subsegment of objects may include heads of the people appearing in the training image.

The method may include converting, using an encoder of the primary part of the composite neural network, the training image into a latent space. A decoder of the primary part of the composite neural network may be trained using the latent space.

Training the primary part of the composite neural network may set a plurality of weights of the primary part of the composite neural network. Freezing the primary part of the composite neural network may include freezing the plurality of weights of the primary part of the composite neural network.

An activation of the primary part of the composite neural network may include a heatmap indicating probabilities where the primary segment of objects appear at locations in the training image.

Each object of the first subsegment of objects may be contained within the primary segment of objects.

Training the secondary part of the composite neural network may further be based on the training image.

The method may include freezing the secondary part of the composite neural network after training the secondary part of the composite neural network and after freezing the secondary part of the composite neural network, training, using activations of the secondary part of the composite neural network, a tertiary part of the composite neural network to identify a second subsegment of objects or a feature of the second subsegment of objects in the training image. The second subsegment of objects may be a subset of the subsegment of objects. The method may include freezing the tertiary part of the composite neural network after training the tertiary part of the composite neural network and after freezing the tertiary part of the composite neural network, training, using activations of the secondary part of the composite neural network, a quaternary part of the composite neural network to identify a third subsegment of objects or a feature of the third subsegment of objects in the training image. The third subsegment of objects may be a subset of the subsegment of objects.

According to another embodiment, a method of training a machine learning model includes training a first channel of a neural network to identify a primary segment of objects in a training image and while training the first channel, training, using the training image, a second channel of the neural network to identify a subsegment of objects or a feature of the subsegment of objects in the training image. The subsegment of objects is a subset of the primary segment of objects.

The primary segment of objects may include portions of objects appearing in the training image. The subsegment of objects may include sub-portions of the portions of the objects appearing in the training image. The primary segment of objects may include upper bodies of people appearing in the training image. The subsegment of objects may include heads of the people appearing in the training image.

The method may include converting, using an encoder of the neural network, the training image into a latent space. The first channel and the second channel may be trained using the latent space.

According to another embodiment, a method of training a machine learning model includes training a first channel of a primary part of a composite neural network to identify a primary segment of objects in a training image and while training the first channel of the primary part of the composite neural network, training, using the training image, a second channel of the primary part of the composite neural network to identify a first subsegment of objects in the training image. The first subsegment of objects is a subset of the primary segment of objects. The method also includes freezing the primary part of the composite neural network after training the first channel and the second channel of the primary part of the composite neural network and after freezing the primary part of the composite neural network, training, using the training image and activations of the primary part of the composite neural network, a third channel of a secondary part of the composite neural network to identify a second subsegment of objects or a feature of the second subsegment of objects in the training image. The second subsegment of objects is a subset of the first subsegment of objects.

The primary segment of objects may include portions of objects appearing in the training image. The first subsegment of objects may include sub-portions of the portions of the objects appearing in the training image. The primary segment of objects may include upper bodies of people appearing in the training image. The first subsegment of objects may include heads of the people appearing in the training image.

The method may include converting, using an encoder of the primary part of the composite neural network, the training image into a latent space. The first channel and the second channel may be trained using the latent space.

Training the first channel and the second channel of the primary part of the composite neural network may set a plurality of weights of the primary part of the composite neural network. Freezing the primary part of the composite neural network may include freezing the plurality of weights of the primary part of the composite neural network.

An activation of the primary part of the composite neural network may be a heatmap indicating probabilities where the primary segment of objects and the first subsegment of objects appear at locations in the training image.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. However, it is to be noted that the appended drawings illustrate only exemplary embodiments and are therefore not to be considered limiting of its scope, may admit to other equally effective embodiments.

FIG. 1 illustrates an example of a system for making predictions based on captured images.

FIG. 2 illustrates an example device in the system of FIG. 1 detecting objects in an image.

FIG. 3 illustrates an example system for training one or more neural networks.

FIG. 4 illustrates an example training device in the system of FIG. 3 training neural networks.

FIG. 5 is a flowchart of an example method for training neural networks performed in the system of FIG. 3.

FIG. 6 illustrates an example training device in the system of FIG. 3 training a neural network.

FIG. 7 is a flowchart of an example method for training a neural network performed in the system of FIG. 3.

FIG. 8 illustrates an example training device in the system of FIG. 3 training neural networks.

FIG. 9 is a flowchart of an example method for training neural networks performed in the system of FIG. 3.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Numerous specific details are set forth in the following description to provide a more thorough understanding of the embodiments of the present disclosure. However, it will be apparent to one of skill in the art that one or more of the embodiments of the present disclosure may be practiced without one or more of these specific details. In other instances, well-known features have not been described in order to avoid obscuring aspects of the present disclosure.

Machine learning may be used to detect or recognize objects that appear within images or videos. For example, a machine learning model (e.g., a neural network) may be trained to analyze frames of a video to detect people that appear in the video. Although it may be common to train a machine learning model to recognize or detect objects within an image or video, the machine learning model typically recognizes parts of objects as fully separated, non-overlapped segments. For example, a machine learning model may be trained to detect or recognize the head, chest, hands, and neck of a person's body as exclusive detections, where detection of one body part is exclusive of another body part. Using such training techniques does not allow neural networks to learn hierarchy of object segments, which may lead to loss optimization competition and an increase in computational expense.

The present disclosure describes various processes for training one or more machine learning models to detect both, a primary segment of objects (e.g., upper bodies) in an image and a subsegment of objects (e.g., heads) within the primary segment of objects. In a first process (which may be referred to as tailing), a primary part of a composite neural network is trained to detect the primary segment of objects. The primary part of the composite neural network is then frozen and its activations are fully or partially interconnected to a secondary part of the composite neural network to detect the subsegment of objects or a feature of the subsegment of objects. Because the secondary part of the composite neural network has the benefit of the knowledge learned by the primary part of the composite neural network (specifically, the localization of the primary segment of objects in images) and because the second part of the composite neural network understands that the subsegment of objects appears in the primary segment of objects, the second part of the composite neural network is generally smaller in size than the primary part of the composite neural network that was independently or separately trained to recognize the primary segment of objects. As a result, the training process trains multiple parts of the composite neural network individually without impacting already trained parts of the neural network. The different parts may be trained on different datasets.

In a second process (which may be referred to as channeling), multiple channels of a neural network are trained together to detect the primary segment of objects and the subsegment of objects. For example, a first channel of the neural network may be trained to recognize the primary segment of objects. While that first channel is being trained, a second channel of the neural network is trained to detect the subsegment of objects or a feature of the subsegment of objects. Any suitable number of channels of the neural network may be trained to detect any suitable number of primary segments of objects or subsegments of objects. As a result, a single neural network with multiple channels is trained to recognize both a primary segment of objects and subsegments of objects.

In a third process, multiple channels of a first part of a composite neural network are trained together to detect different segments or subsegments of objects. The first part of the composite neural network is then frozen and its activations are used to train multiple channels of a second part of the composite neural network to detect different subsegments of objects within the segments or subsegments of objects detected by the first part of the composite neural network. As a result, the third training process produces a composite neural network with multiple channels that detect different segments and subsegments of objects.

These various processes may provide certain technical advantages. For example, using these processes, one or more parts of a composite neural network are trained to detect primary segments of objects (e.g., upper bodies) that appear in an image and subsegments of objects (e.g., heads) within the primary segments of objects. The composite neural network may have a smaller total size than independently or separately trained neural networks that segment an object within an image into multiple parts. Training a neural network with segmentation composition may improve accuracy when the primary segments limit detection regions for subsegments.

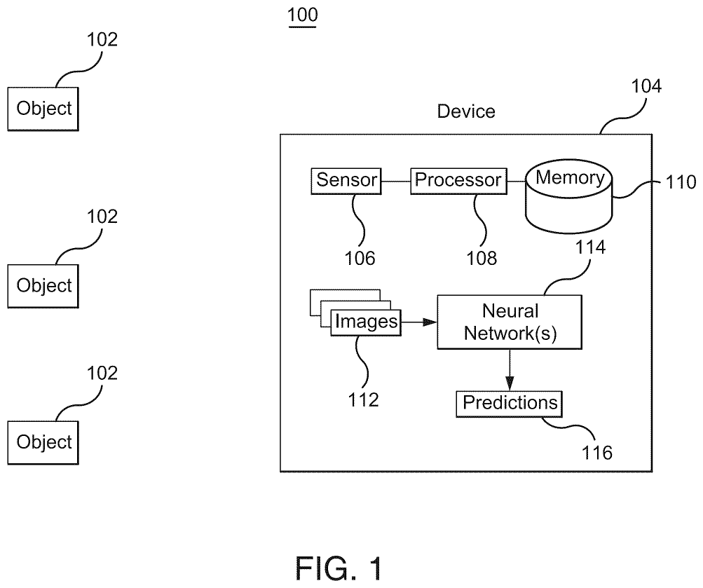

FIG. 1 illustrates an example system 100 for making predictions based on captured images. Generally, the system 100 uses machine learning to detect one or more objects that appear within an image or a series of images. As seen in FIG. 1, the system 100 includes one or more objects 102 and a device 104. The device 104 may generate images of the objects 102 and detect the objects 102 that appear in the images.

The objects 102 may be positioned within or near the system 100. The objects 102 may be any suitable object. In certain embodiments, people may be located in the system 100. The objects 102 may be certain body parts or sections of the bodies of the people (e.g., the upper bodies or the heads).

The device 104 uses machine learning to detect the objects 102 that appear within an image or a series of images. For example, the device 104 may be a camera that captures images or videos of the objects 102 and then applies machine learning to detect the objects 102 that appear in the captured images or video. As seen in FIG. 1, the device 104 includes one or more sensors 106, a processor 108, and a memory 110, which may be configured to perform any of the functions or operations of the device 104 described herein.

The sensor 106 may be any suitable sensor for sensing or capturing visual or optical information. For example, the sensor 106 may form part of a camera that captures images or videos of the objects 102 in the system 100. The sensor 106 may sense visual or optical information in the system 100 and communicate that information to the processor 108. The terms “camera” and “sensor” are generally used interchangeably throughout the disclosure provided herein, and neither term is intended to be limiting as to the scope of the disclosure provided herein since, in either case, these terms are intended to generally describe a device that is at least able to generate a stream of visual images (e.g., frames) based on a field-of-view of one or more optical components (e.g., lenses), and an image sensor (e.g., CCD, CMOS sensor, etc.) disposed within the “camera” or “sensor.” In some embodiments, the cameras or sensors are capable of delivering video at a 720p, 2K video resolution, or UHD (2160 p) video resolution, or DCI 4K (i.e., 4K) video resolution, or 8K or greater video resolution.

The processor 108 is any electronic circuitry, including, but not limited to one or a combination of microprocessors, microcontrollers, application specific integrated circuits (ASIC), application specific instruction set processor (ASIP), and/or state machines, that communicatively couples to memory 110 and controls the operation of the device 104. The processor 108 may be 8-bit, 16-bit, 32-bit, 64-bit or of any other suitable architecture. The processor 108 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The processor 108 may include other hardware that operates software to control and process information. The processor 108 executes software stored on the memory 110 to perform any of the functions described herein. The processor 108 controls the operation and administration of the device 104 by processing information (e.g., information received from the sensor 106 and memory 110). The processor 108 is not limited to a single processing device and may encompass multiple processing devices.

The memory 110 may store, either permanently or temporarily, data, operational software, or other information for the processor 108. The memory 110 may include any one or a combination of volatile or non-volatile local or remote devices suitable for storing information. For example, the memory 110 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 110, a disk, a CD, or a flash drive. In particular embodiments, the software may include an application executable by the processor 108 to perform one or more of the functions described herein.

In some embodiments, the sensor 106 and the processor 108 capture and generate one or more images 112 of the system 100. As discussed previously, one or more of the objects 102 may appear in the captured images 112. The device 104 uses machine learning to analyze the images 112 and to detect the objects 102 that appear in the images 112. In the example of FIG. 1, the device 104 applies one or more neural networks 114 to make one or more predictions 116. For example, a neural network 114 may analyze information in the images 112 to predict the locations of the objects 102 that appear in the images 112. As another example, a neural network 114 may analyze information in the images 112 to distinguish or recognize the objects 102 appearing within the images 112. The device 104 may predict any suitable information about the objects 102 from the images 112. For example, the device 104 may predict the number of objects 102 that appear in the images 112 or the positions of the objects 102 that appear in the images 112.

Existing devices 104 may experience challenges accurately identifying both a primary segment of objects 102 and a subsegment or subset of objects within the primary segment of objects 102 from the images 112. The present disclosure describes various processes of training multichanneled or composite neural networks to detect or recognize both a primary segment of objects 102 that appear in the images 112 and one or more subsegments or subsets of objects that appear within the primary segment of objects 102 in the images 112. For example, the device 104 may store and use a composite neural network that has a primary part which detects or recognizes the upper bodies of people that appear in the images and a second part that detects or recognizes the heads of those people. As another example, the device 104 may store and use a neural network with a first channel that detects the upper bodies of people and a second channel that detects the heads of people. As a result, the device 104 uses less computing resources (e.g., processing resources, memory resources, and storage resources) to store and use these neural networks.

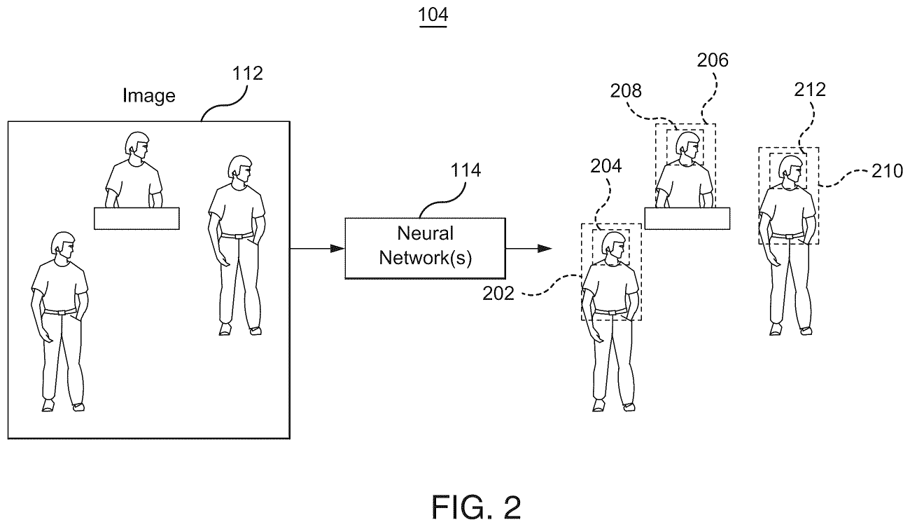

FIG. 2 illustrates an example device 104 in the system 100 of FIG. 1 detecting objects 102 in an image 112. As seen in FIG. 2, the device 104 has received or captured the image 112. Multiple people may appear in the image 112. The device 104 may use a neural network 114 to detect or recognize objects appearing in the image 112 and a subsegment of objects within the objects in the image 112. As seen in FIG. 2, the device 104 uses a neural network 114 to detect the upper bodies and the heads of the people in the image 112. The heads are a subsegment of the upper bodies and appear within the upper bodies. The device 104 uses a neural network 114 to detect the upper bodies 202, 206, and 210 of the people appearing in the image 112. Additionally, the device 104 may use the neural network 114 to detect the heads 204, 208, and 212 of the people appearing in the image 112. The heads 204, 208, and 212 are part of the upper bodies 202, 206, and 210.

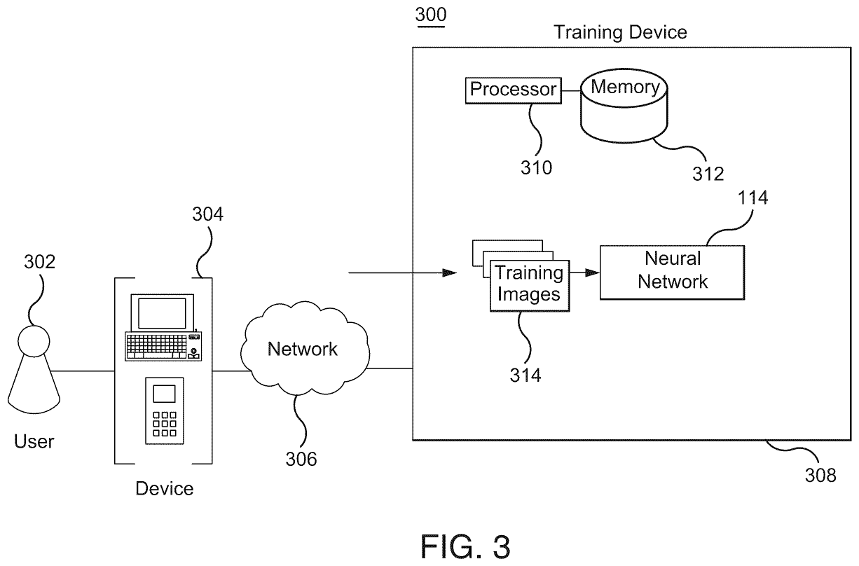

FIG. 3 illustrates an example system 300 for training a neural network 114. As seen in FIG. 3, the system 300 includes one or more devices 304, a network 306, and a training device 308. Generally, the system 300 trains a neural network 114 to detect or recognize both a primary segment of objects appearing in an image and a subsegment or subset of objects within the primary segment of objects (or features of the subsegment or subset of objects). For example, a system 300 may train the neural network 114 to recognize the upper bodies of people appearing in an image and the heads of the people (or a feature of the heads, such as size or orientation), which are part of the upper bodies.

A user 302 uses the device 304 to instruct or operate the training device 308. For example, the user 302 may use the device 304 to issue instructions to the training device 308 to train the neural network 114. In some embodiments, the device 304 and the training device 308 are embodied in the same device. The device 304 is any suitable device for communicating with components of the system 300 over the network 306. As an example and not by way of limitation, the device 304 may be a computer, a laptop, a wireless or cellular telephone, an electronic notebook, a personal digital assistant, a tablet, or any other device capable of receiving, processing, storing, or communicating information with other components of the system 300. The device 304 may be a wearable device such as a virtual reality or augmented reality headset, a smart watch, or smart glasses. The device 304 may also include a user interface, such as a display, a microphone, keypad, or other appropriate terminal equipment usable by the user 302. The device 304 may include a hardware processor, memory, or circuitry configured to perform any of the functions or actions of the device 304 described herein. For example, a software application designed using software code may be stored in the memory and executed by the processor to perform the functions of the device 304.

The network 306 is any suitable network operable to facilitate communication between the components of the system 300. The network 306 may include any interconnecting system capable of transmitting audio, video, signals, data, messages, or any combination of the preceding. The network 306 may include all or a portion of a public switched telephone network (PSTN), a public or private data network, a local area network (LAN), a metropolitan area network (MAN), a wide area network (WAN), a local, regional, or global communication or computer network, such as the Internet, a wireline or wireless network, an enterprise intranet, or any other suitable communication link, including combinations thereof, operable to facilitate communication between the components.

The training device 308 trains the neural network 114 to detect or recognize a primary segment of objects that appear within images and a subsegment or subset of objects within the detected primary segment of objects. As seen in FIG. 3, the training device 308 includes a processor 310 and a memory 312 which may be configured to perform the functions or actions of the training device 308 described herein.

The processor 310 is any electronic circuitry, including, but not limited to one or a combination of microprocessors, microcontrollers, application specific integrated circuits (ASIC), application specific instruction set processor (ASIP), and/or state machines, that communicatively couples to memory 312 and controls the operation of the training device 308. The processor 310 may be 8-bit, 16-bit, 32-bit, 64-bit or of any other suitable architecture. The processor 310 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The processor 310 may include other hardware that operates software to control and process information. The processor 310 executes software stored on the memory 312 to perform any of the functions described herein. The processor 310 controls the operation and administration of the training device 308 by processing information (e.g., information received from the device 304, network 306, and memory 312). The processor 310 is not limited to a single processing device and may encompass multiple processing devices.

The memory 312 may store, either permanently or temporarily, data, operational software, or other information for the processor 310. The memory 312 may include any one or a combination of volatile or non-volatile local or remote devices suitable for storing information. For example, the memory 312 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 312, a disk, a CD, or a flash drive. In particular embodiments, the software may include an application executable by the processor 310 to perform one or more of the functions described herein.

The training device 308 receives one or more training images 314 (e.g., from the device 304). The training device 308 may use one or more of the training images 314 to train and test the neural network 114. The training images 314 may include labeled data that identifies a primary segment of objects within the training images 314 and a subsegment of objects within those objects. For example, the training images 314 may be images of people and the labeled data may identify the upper bodies of those people and the heads of those people within their upper bodies. The training device 308 uses the training images 314 and the labeled data to teach or train the neural network 114 to detect or recognize the primary segment of objects appearing within the training images 314 and the subsegment of objects within the primary segment of objects.

In some embodiments, after the training device 308 has trained the neural network 114, the training device 308 uses some of the training images 314 to verify or test the neural network 114. For example, the training device 308 may apply or use the neural network 114 to detect or recognize the primary segment of objects and a subsegment of objects within some of the training images 314. The training device 308 may use the labeled data accompanying those training images 314 to determine an accuracy of the predictions of the neural network 114. If the accuracy of the neural network 114 does not meet a desired threshold, then the training device 308 may continue training the neural network 114 to improve accuracy. If the accuracy meets the desired threshold, then the training device 308 may consider the neural network 114 trained.

The training device 308 may communicate the neural network 114 to the device 304 after the neural network 114 is trained. The user 302 may then deploy the neural network 114 by installing or storing the neural network 114 in other devices (e.g., cameras). These other devices may store and use the neural network 114 to detect the primary segment of objects appearing within images and the subsegment of objects within the primary segment of objects. For example, a camera may use the neural network 114 to identify the upper bodies and the heads of people appearing in images or videos generated by the camera.

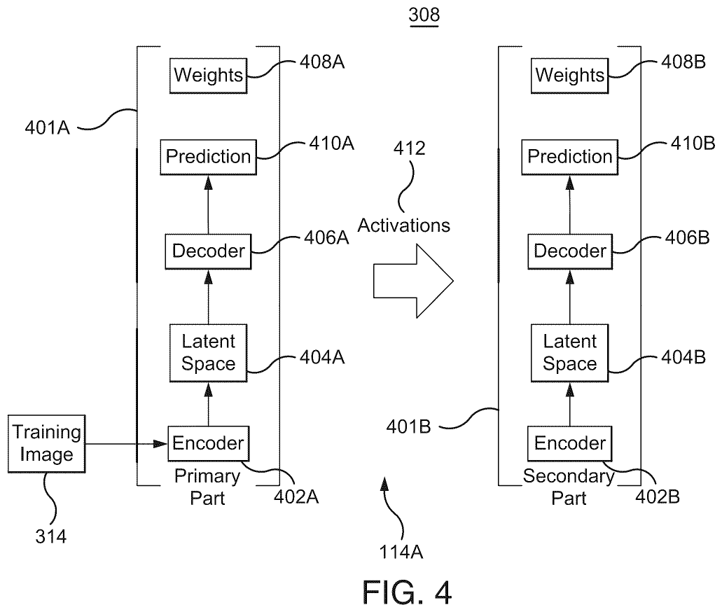

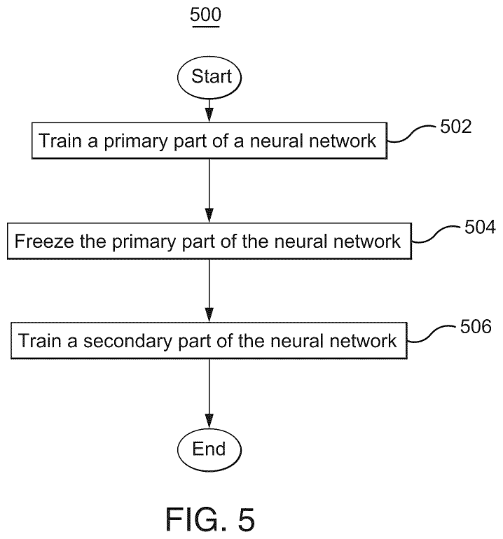

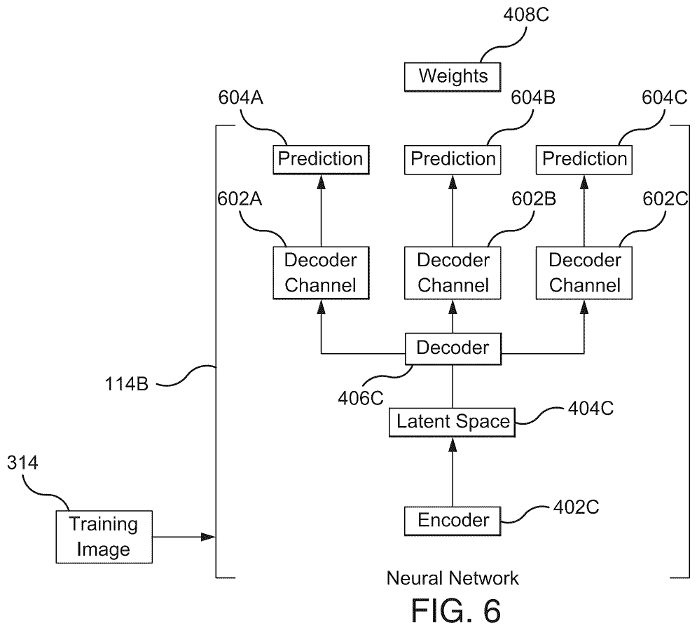

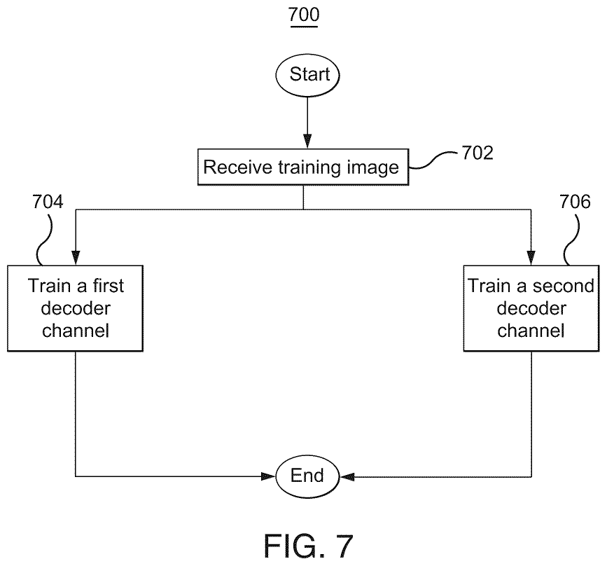

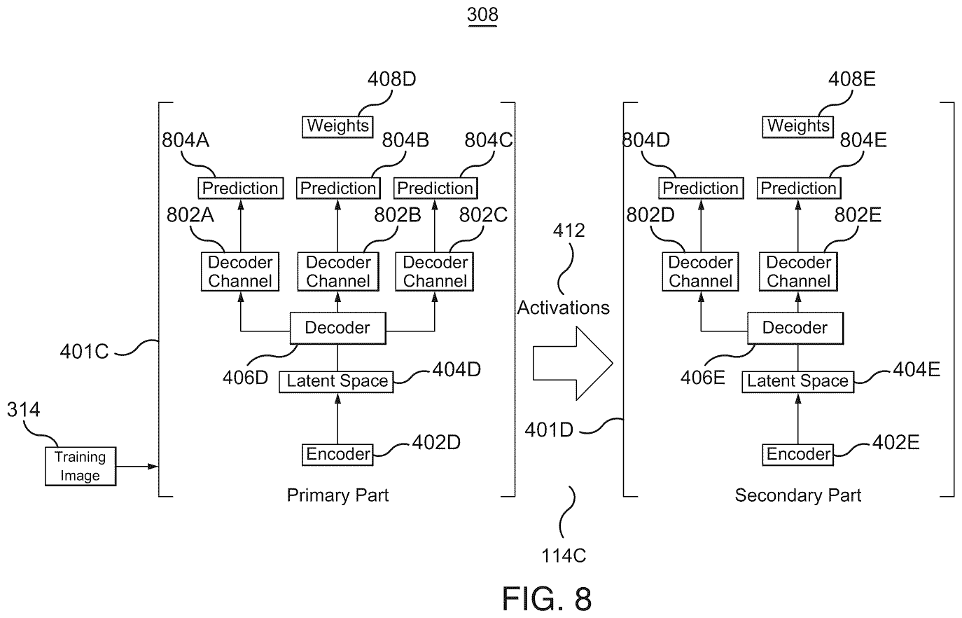

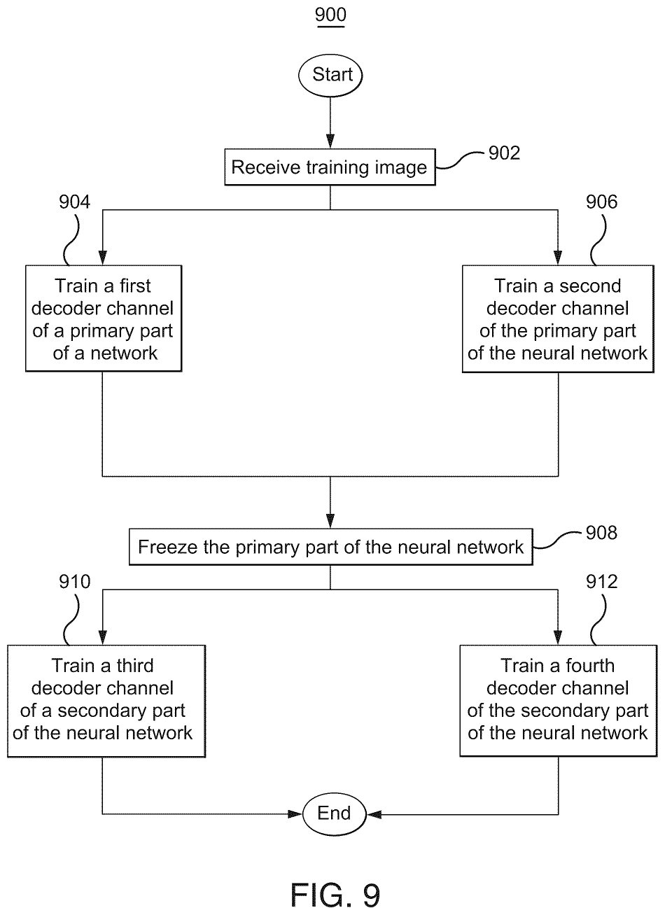

The training device 308 may train the neural network 114 using one or more processes. In a first process (which may be referred to as tailing), the neural network 114 is a composite neural network 114, and the training device 308 trains a first part of the composite neural network 114 to detect or recognize a primary segment of objects (e.g., upper bodies) that appear within an image. After the first part of the composite neural network 114 is trained, the training device 308 freezes the first part of the composite neural network 114 and trains a second part of the composite neural network 114 to detect or recognize a subsegment of objects (e.g., heads). This process will be discussed with respect to FIGS. 4 and 5. In a second process (which may be referred to as channeling), the training device 308 trains multiple channels of a neural network 114 together. For example, the training device 308 may train a first channel of the neural network 114 to detect a primary segment of objects (e.g., upper bodies) that appear in an image. While the training device 308 is training the first channel, the training device 308 may also train a second channel of the neural network 114 to detect a subsegment of objects (e.g., heads). This process will be discussed with respect to FIGS. 6 and 7. In a third process, the training device 308 uses concepts from the tailing process and the channeling process. The training device 308 first trains multiple channels of a first part of a composite neural network 114 to recognize various objects (e.g., upper bodies and heads) that appear in an image. After the first part of the composite neural network 114 is trained, the training device 308 freezes the first part of the composite neural network 114. The training device 308 then trains multiple channels of a second part of the composite neural network 114 to detect other objects that appear in the image, such as subsegments of objects (e.g., eyes, noses, mouths). This process will be discussed with respect to FIGS. 8 and 9.

FIG. 4 illustrates an example training device 308 in the system 300 of FIG. 3 training a machine learning model. In the example of FIG. 4, the training device 308 trains multiple parts 401 of a composite neural network 114A using the tailing process. During this training process, the training device 308 trains a primary part 401A of the composite neural network 114A and then freezes the primary part 401A of the composite neural network 114A. The training device 308 then trains a secondary part 401B of the composite neural network 114A using activations from the primary part 401A of the composite neural network 114A. In this manner, the training device 308 trains multiple parts 401 of the composite neural network 114A to detect or recognize different primary segments of objects (e.g., upper bodies) or subsegments of objects (e.g., heads) that appear in an image.

The training process begins with the training device 308 receiving a training image 314. As discussed previously, the training image 314 may be provided by a user or another device. The training image 314 may include a primary segment of objects or subsegments of objects that the training device 308 is training the neural network 114A to detect or recognize. Additionally, the training image 314 may include labeled data that identifies the primary segment of objects or subsegments of objects that appear in the training image 314. The training device 308 may use the labeled data to verify predictions made about the training image 314. The training device 308 uses this information to teach the neural network 114A how to recognize the primary segment of objects and subsegments of objects that appear in the training image 314.

The training device 308 passes the training image 314 to an encoder 402A of the primary part 401A of the neural network 114A. The encoder 402 analyzes the training image 314 to convert the training image 314 into a latent space 404A. The latent space 404A may be a representation or an embedding of the training image 314. In this manner, the encoder 402A converts the training image 314 from a pictorial representation to a different representation that may be analyzed by a machine. As more training images 314 are presented, the encoder 402A better learns the features or aspects in the training images 314 that may be representative of a primary segment and subsegments of objects (e.g., upper bodies, heads, noses).

A decoder 406A of the primary part 401A of the neural network 114A analyzes the latent space 404A to make one or more predictions 410A. For example, the decoder 406A may analyze the latent space to predict the locations or positions of a primary segment of objects (e.g., upper bodies) that appears in the training image 314. As more training images 314 are presented, the decoder 406A learn various patterns or sequences in the latent space 404A that indicate the presence and localization of the primary segment of objects.

The encoder 402A and the decoder 406A may learn which features or patterns are more indicative or less indicative of certain objects. In response, the encoder 402A and the decoder 406A may set weights 408A of the primary part 401A of the neural network 114A that emphasize or de-emphasize these features and patterns. For example, if a particular pattern or sequence is strongly indicative of a particular class of objects, the encoder 402A and the decoder 406A may set weights 408A that increases the influence of that pattern or sequence. On the other hand, if a particular pattern or sequence is not indicative of class of objects, the encoder 402A and the decoder 406A may set weights 408A that de-emphasizes that pattern or sequence.

After the primary part 401A of the composite neural network 114A has been trained with the training image 314, the training device 308 may test the accuracy of the primary part 401A of the neural network 114A. For example, the training device 308 may apply the primary part 401A of the neural network 114A to a training image 314. The primary part 401A of the neural network 114A may then make a prediction 410A of whether and/or where a primary segment of objects (e.g., upper bodies) appears in that training image 314 by applying the weights 408A. The training device 308 may compare the prediction 410A with labeled data in the training image 314 to assess or determine the accuracy of the primary part 401A of the composite neural network 114A. If the accuracy of the primary part 401A of composite neural network 114A meets a desired threshold, the training device 308 may consider primary part 401A of the neural network 114A trained.

After the primary part 401A of the neural network 114A is trained with the training images 314, the training device 308 freezes the primary part 401A of the neural network 114A. When freezing primary part 401A of the neural network 114A, the training device 308 freezes the weights 408A of the primary part 401A of the composite neural network 114A so that the weights 408A no longer change during the training process. The training device 308 then uses the activations 412 of the primary part 401A of the composite neural network 114A to train the secondary part 401B of the composite neural network 114A. The activations 412 of the primary part 401A of the neural network 114A may be the outputs of activation functions of the nodes of the primary part 401A of the neural network 114A. Generally, the activations 412 may indicate where in the training images 314 the primary part 401A of the neural network 114A believed a primary segment of objects appears. For example, the predictions 114AA from the primary part 401A of the neural network 114A are included in the activations 412 that are shared with the secondary part 401B of the composite neural network 114A.

The training device 308 may use the activations 412 (e.g., partially or fully) to train the secondary part 401B of the composite neural network 114A. After the primary part 401A of the neural network 114A is frozen, the training device 308 passes the activations 412 (e.g., partially or fully) of the primary part 401A of the neural network 114A to the secondary part 401B of the composite neural network 114A. In this manner, the secondary part 401B of the composite neural network 114A has information about where the primary part 401A of the neural network 114A thought the primary segment of objects (e.g., upper bodies) appears in the training images 314. The training device 308 may also pass the training images 314 to the secondary part 401B of the composite neural network 114A. In some embodiments, the training device 308 does not pass the training images 314 to the secondary part 401B of the composite neural network 114A.

The secondary part 401B of the neural network 114A includes an encoder 402B that analyzes the activations 412 from the primary part 401A of the neural network 114A to generate a latent space 404B. The latent space 404B may be a representation or an embedding of the activations 412. As more training images 314 and activations 412 are presented, the encoder 402B better learns the features or aspects that may be representative of a subsegment of objects (e.g., heads) that appear within the primary segments of objects detected by the primary part 401A of the neural network 114A.

The secondary part 401B of the composite neural network 114A includes a decoder 406B that analyzes the latent space 404B to make predictions 410B. For example, the decoder 406B may be trained to detect patterns or sequences in the latent space 404B that are indicative of the subsegment of objects appearing within the primary segments of objects detected by the primary part 401A of the neural network 114A (and represented by the activations 412). The more training images 314 and activations 412 are presented, the better the decoder 406B learns the patterns or sequences that indicate the presence of the subsegment of objects within the detected primary segments of objects.

During training, the encoder 402B and the decoder 406B set the weights 408B of the secondary part 401B of the neural network 114A. The weights 408B may indicate certain features or sequences that are indicative of the presence of the subsegment of objects. For example, if a particular feature or pattern in the activations 412 or the latent space 404B are indicative of the presence of the subsegment of objects, the encoder 402B and the decoder 406B may set the weights 408B that emphasize that feature or pattern. On the other hand, if certain features or patterns are not indicative of the presence of the subsegment of objects, then the encoder 402B and the decoder 406B may set weights 408B that de-emphasize those features or patterns.

After training the secondary part 401B of the neural network 114A, the training device 308 may test the accuracy of the secondary part 401B of the neural network 114A similar to the process described for testing the accuracy of the primary part 401A of the neural network 114A. If the accuracy of the secondary part 401B of the neural network 114A meets a threshold, the training device 308 may consider the secondary part 401B of the composite neural network 114A trained. In this manner, the training device 308 trains the primary part 401A of the neural network 114A to recognize a primary segment of objects (e.g., upper bodies) and the secondary part 401B of the neural network 114A to recognize a subsegment of objects (e.g., heads) appearing within the primary segment of objects. In some embodiments, because the secondary part 401B of the neural network 114A is trained using information from the primary part 401A of the neural network 114A, the secondary part 401B of the neural network 114A is smaller in size compared to another neural network that was independently trained to recognize the subsegment of objects in the training images 314. As a result, it may take less computing resources to store and apply the composite neural network 114A with the parts 401A and 401B than two independently trained neural networks, which may allow certain computing systems with limited computing resources to use the neural network 114A. Moreover subsegmentation and partial training may provide benefits in accuracy of detection and the ability of independent training

As an example, the training device 308 may first train the primary part 401A of the neural network 114A to detect or recognize the upper bodies of people that appear in the training images 314. The encoder 402A may generate the latent space 404A using the training images 314. The decoder 406A then learns to detect or predict the upper bodies of people that appear in the training images 314 based on patterns or sequences in the latent space 404A. The encoder 402A and the decoder 406A may set the weights 408A that are used by the primary part 401A of the neural network 114A to detect the segments of upper bodies in images. After the primary part 401A of the neural network 114A is trained, the training device 308 freezes the primary part 401A of the neural network 114A and the weights 408A.

The training device 308 then trains the secondary part 401B of the neural network 114A to detect or recognize the heads of people that appear in the training images 314. To train the secondary part 401B of the neural network 114A, the training device 308 may fully (all activations) or partially (only up to latent space) interconnect the secondary part 401B of the neural network 114A with the activations 412 from the primary part 401A of the neural network 114A, which may include the predictions 410A. The training device 308 then trains the secondary part 401B of the neural network 114A to look within the upper bodies detected by the primary part 401A of the neural network 114A to detect or recognize the heads of the people in the training images 314. The encoder 402B and the decoder 406B may set the weights 408B that are used to detect or predict segments of the heads of people in images. After the secondary part 401B of the neural network 114A is trained, the primary part 401A of the neural network 114A may be able to detect or recognize the upper bodies of people that appear in images, and the secondary part 401B of the neural network 114A may be able to detect or recognize the heads of the people in the images. As a result, a device using the composite neural network 114A with the parts 114AA and 114AB may determine the upper bodies and the heads of people that appear in images, which reduces the computing resources required of the device relative to using two, independently trained neural networks or detecting the objects as multiple independent segments, in certain embodiments.

The training device 308 may repeat this training process to train any suitable number of parts 401 in the composite neural network 114A. For example, the training device 308 may train another part 401 of the neural network 114A to detect or recognize another subsegment of objects (e.g., chests) that appear in the primary segment of objects detected by the primary part 401A of the neural network 114A. After the training device 308 trains the secondary part 401B of the composite neural network 114A, the training device 308 may pass the activations 412 of the primary part 401A of the composite neural network 114A to the other part 401 of the neural network 114A. The other part 401 of the neural network 114A may then learn to detect the subsegment of objects in the primary segment of objects detected by the primary part 401A of the neural network 114A. As another example, the training device 308 may train the other part 401 of the neural network 114A to detect or recognize a subsegment of objects (e.g., eyes) that appear in the subsegment of objects detected by the secondary part 401B of the neural network 114A. After the training device 308 trains the secondary part 401B of the neural network 114A, the training device 308 may freeze the secondary part 401B of the neural network 114A. The training device 308 may then pass the activations 412 of the secondary part 401B of the neural network 114A to the other part 401 of the neural network 114A. The other part 401 of the composite neural network 114A may then learn to detect the subsegment of objects in the subsegment of objects detected by the secondary part 401B of the neural network 114A using the activations 412 of the secondary part 401B of the neural network 114A.

The training device 308 is not limited to training neural networks 114A to detect the presence or location of a primary segment of objects or a subsegment of objects. The training device 308 may train a part 401 of the neural network 114A to detect any suitable feature of a primary segment or subsegment of objects. For example, the training device 308 may train the secondary part 401B of the neural network 114A to detect the size, number, or orientation of a subsegment of objects in the primary segment of objects detected by the primary part 401A of the neural network 114A.

FIG. 5 is a flowchart of an example method 500 for training a primary part 401A and a secondary part 401B of a neural network 114A performed in the system 300 of FIG. 3. In particular embodiments, the training device 308 performs the method 500. By performing the method 500, the training device 308 trains multiple parts 401 of a neural network 114A to detect or recognize a primary segment of objects and a subsegment of objects that appear in images.

In block 502, the training device 308 trains a primary part 401A of the composite neural network 114A. The training device 308 may receive one or more training images 314 accompanied by labeled data. The training device 308 uses an encoder 402A of the primary part 401A of the neural network 114A to generate the latent space 404A. The decoder 406A then learns to detect or recognize a primary segment of objects in the training images 314 by analyzing patterns or sequences that appear in the latent space 404A. For example, the decoder 406A may recognize the upper bodies of people that appear in the training images 314 based on patterns or sequences that appear in the latent space 404A. The encoder 402A and the decoder 406A may set the weights 408A of the primary part 401A of the neural network 114A that are used to detect patterns or sequences that indicate the presence of an upper body of a person in an image. In this manner, the training device 308 trains the primary part 401A of the neural network 114A to recognize a primary segment of objects within the training images 314.

In block 504, the training device 308 freezes the primary part 401A of the neural network 114A. After the primary party 401A of the neural network part 114A is trained, the training device 308 freezes the primary party 401A of the composite neural network 114A, which freezes the weights 408A. In this manner, the training device 308 prevents the primary part 401A of the neural network part 114A and the weights 408A from changing in subsequent steps.

After the primary part 401A of the composite neural network primary part 114A is frozen, the training device 308 trains the secondary part 401B of the neural network 114A in block 506. The training device 308 may provide the secondary part 401B of the neural network 114A with the activations 412 of the primary part 401A of the neural network 114A. The training device 308 uses this information to train the secondary party 401B of the neural network 114A to detect or recognize a subsegment of objects within the primary segment of objects in the training images 314 detected by the primary part 401A of the neural network 114A. For example, the training device 308 may train the secondary part 401B of the composite neural network 114A to detect the heads of people, which may be within the upper bodies of the people in the training images 314 detected by the primary part 401A of the neural network 114A. The training of the secondary party 401B of the neural network 114A may be simpler than the training of the primary part 401A of the neural network 114A, because the secondary party 401B of the neural network 114A would understand that the subsegment of objects appears within the primary segment of objects detected by the primary part 401A of the neural network 114A. As a result, the secondary part 401B of the neural network 114A need not train itself using the entire training image 314 but may limit the bulk of its learning and analysis to the primary segment of objects in the training image 314 detected by the primary part 401A of the neural network 114A. In this manner, the training device 308 trains the composite neural network 114A to detect or recognize segments of objects and subsegments of objects within images.

FIG. 6 illustrates an example training device 308 in the system 300 of FIG. 3 training a neural network 114B. In the example of FIG. 6, the training device 308 trains the neural network 114B using the channeling process. Generally, in this training process, the training device 308 trains multiple decoder channels of the neural network 114B together. The neural network 114B may then be used to detect or recognize objects and subsegments of objects that appear in images.

The training process begins with the training device 308 receiving one or more training images 314. The training images 314 may include primary segments of objects and subsegments of objects that the training device 308 will train the neural network 114B to detect or recognize. The training images 314 may also include labeled data that indicates the primary segments of objects and subsegments of objects in the training images 314. The training device 308 may use the labeled data to verify predictions made about the training image 314.

The training device 308 passes a training image 314 to the encoder 402C of the neural network 114B. The encoder 402C analyzes the training image 314 to convert the training image 314 into a latent space 404C. The latent space 404C may be a representation or an embedding of the training image 314. In this manner, the encoder 402C converts the training image 314 from a pictorial representation to a different representation that may be analyzed by a machine. As more training images 314 are presented, the encoder 402C better learns the features or aspects in the training images 314 that may be indicative of a primary segment of objects (e.g., upper bodies) or subsegments of objects (e.g., heads, arms, etc.).

The training device 308 then trains the decoder 406C of the neural network 114B, which includes training multiple decoder channels 602 of the decoder 406C together. In the example of FIG. 6, the decoder 406C includes the decoder channels 602A, 602B, and 602C. The training device 308 trains the decoder channels 602A, 602B, and 602C together. Each decoder channel 602A, 602B, or 602C may be trained to analyze the latent space 404C and to detect or recognize a different primary segment of objects or a different subsegment of objects in the training image 314 based on particular patterns or sequences in the latent space 404C. Because the training device 308 trains the channels 602A, 602B, and 602C together, detection of the primary segment of objects and subsegments of objects are not learned independently, but are rather jointly learned. As a result, the channels 602A, 602B, and 602C may learn relationships (e.g., hierarchical relationships) between or amongst the different primary segment of objects and subsegments of objects, which may improve the accuracy of the neural network 114B in certain embodiments. For example, if the channel 602A is trained to detect or recognize the upper bodies of people and the channel 602B is trained to detect or recognize the heads of people, the neural network 114B might learn the intra-object relationships and contextual information, like the relationship between head and upper body, which might improve detection accuracy.

As the channels 602A, 602B, and 602C are trained, the encoder 402C and the channels 602A, 602B, and 602C set weights 408C of the neural network 114B that are used to detect or recognize the primary segments of objects or subsegments of objects in the training images 314. For example, if the decoder channels 602A, 602B, and 602C determine that a particular pattern or a sequence is indicative of a primary segment of objects or a subsegment of objects, the channels 602A, 602B, and 602C may set the weights 408C to emphasize the pattern or sequence when making predictions. On the other hand, if the decoder channels 602A, 602B, and 602C determine that a particular pattern or sequence is not indicative of a particular primary segment of objects or subsegment of objects, then the neural network 114B may set the weights 408C to de-emphasize that pattern or sequence.

The training device 308 may test or verify the neural network 114B after the training process is complete. For example, the training device 308 may test the neural network 114B against a training image 314 so that the neural network 114B generates predictions 604 by applying the weights 408C to the training image 314. Specifically, the decoder channels 602A, 602B, and 602C may generate predictions 604A, 604B, and 604C. For example, the decoder channel 602A may generate a prediction 604A for the semantic segment (e.g., both presence and localization) of upper bodies in the training image 314. The decoder channel 602B may generate a prediction 604B for the semantic segment of heads in the training image 314. The decoder channel 602C may generate a prediction for the semantic segment of noses in the training image 314. In some embodiments, the predictions 604 include heatmaps indicating the probability of certain portions of the training image 314 including a primary segment of objects or a subsegment of objects. The predictions 604 may indicate the predicted semantic segment of the objects or subsegment of objects within the training image 314. The training device 308 may compare the predictions 604 with labeled data accompanying the training image 314 to determine an accuracy of the neural network 1146. If the accuracy meets a desired threshold, the training device 308 may consider the neural network 1146 trained. If the accuracy does not meet the desired threshold, then the training device 308 may continue training the neural network 114B to improve its accuracy.

In an example operation, the training device 308 may receive a training image 314 that includes multiple people. The training device 308 may pass the training image 314 to the encoder 402C so that the encoder 402C may generate the latent space 404C. The training device 308 then trains the decoder channel 602A to detect or recognize the upper bodies of the people in the training image 314. For example, the channel 602A may analyze the latent space 404C to detect patterns or sequences that are indicative of the presence or position of upper bodies in the training image 314.

While the training device 308 is training the channel 602A, the training device 308 may also be training decoder channels 602B and 602C to detect or recognize subsegments of objects within the upper bodies in the training image 314. For example, the training device 308 may train the decoder channel 602B to detect the heads of the people within the upper bodies, and the training device 308 may train the channel 602C to detect the eyes of the people within the upper bodies and heads. The decoder channels 602B and 602C may detect patterns or sequences in the latent space 404C that are indicative of the presence or positions of the heads or eyes of the people in the training image 314.

After the training is complete, the decoder channels 602A, 602B, and 602C may be able to detect or recognize the upper bodies, heads, and eyes of people in images. Because the channels 602A, 602B, and 602C were trained together, the neural network 114B may have weights 408C that indicate the relationships (e.g., contextual relationships and hierarchical relationships) between the upper bodies, heads, and eyes of people. For example, the weights 408C may reveal that the eyes are within the heads and that the heads are near the top of the upper bodies. In this manner, the training device 308 trains a single neural network 114B that includes the encoder 402C and the decoder 406C with channels 602A, 602B, and 602C to detect primary segments of objects and subsegments of objects within the primary segments of objects. The single neural network 114B may use less computing resources than conventional techniques that use two or more neural networks to detect primary segments of objects and subsegments of objects.

The neural network 114B may include any suitable number of decoder channels 602, and the training device 308 may train these channels 602 together during the training process. Additionally, the training device 308 is not limited to training the channels 602 to detect the presence or location of primary segments of objects or subsegments of objects. The training device 308 may train a channel 602 to detect any suitable feature of a primary segment of objects or subsegment of objects. For example, the training device 308 may train a channel 602 to detect the size, number, or orientation of a primary segment of objects or subsegment of objects.

FIG. 7 is a flowchart of an example method 700 for training the neural network 114B performed in the system 300 of FIG. 3. In particular embodiments, the training device 308 performs the method 700. By performing the method 700, the training device 308 trains multiple decoder channels 602 of the neural network 114B together to detect or recognize primary segments of objects and subsegments of objects that appear in images.

In block 702, the training device 308 receives a training image 314. The training image 314 may include primary segments of objects and subsegments of objects that the training device 308 will train the neural network 114B to detect or recognize. For example, the training image 314 may include the upper bodies and heads of people. The training image 314 may also be accompanied by labeled data that indicates the primary segments of objects or subsegments of objects that appear in the training image 314. The training device 308 may use the labeled data to verify predictions made about the training image 314.

In block 704, the training device 308 trains a first decoder channel 602A of the neural network 114B. For example, an encoder 402C of the neural network 114B may first generate the latent space 404C using the training image 314. The decoder on the channel 602A may then analyze the latent space 404C to learn patterns or sequences that are indicative of the presence and localization of primary segments of objects in the training image 314. For example, the training device 308 may train the decoder channel 602A to detect or recognize patterns or sequences that indicate the presence and localization of upper bodies of people that appear in the training image 314. The encoder 402C and the decoder 406C with the channel 602A may set weights 408C that emphasize these patterns or sequences.

While the training device 308 is training the decoder channel 602A, the training device 308 also trains the decoder on the second channel 602B in block 706. As a result, the first decoder channel 602A and the second decoder channel 602B are trained to detect separate objects or subobjects together. The second decoder channel 602B may analyze the latent space 404C to learn patterns or sequences that are indicative of a subsegment of objects within the primary segments of objects that appears in the training image 314. For example, the second decoder channel 602B may recognize the heads of people that appear within the upper bodies in the training image 314. In certain embodiments, because the training device 308 trains the decoder of the first decoder channel 602A and the decoder of the second channel 602B together, the neural network 114B may learn the relationships (e.g., contextual relationships and hierarchical relationships) between the primary segment of objects and the subsegment of objects that the first decoder channel 602A and the second decoder channel 602B are trained to detect or recognize. For example, the neural network 114B may learn the relationships between the upper bodies and the heads of people. In this manner, the training device 308 trains the neural network 114B to detect a primary segment of objects and a subsegment of objects that appear in images.

FIG. 8 illustrates an example training device 308 in the system 300 of FIG. 3 training a primary part 401C and a secondary part 401D of a neural network 114C. In the example of FIG. 8, the training device 308 uses a combination of the tailing and channeling processes. Generally, in this training process, the training device 308 trains the primary part 401C of the neural network part 114C, which includes training a decoder 406D with multiple channels 802 together. The training device 308 then freezes the weights 408D of the primary part 401C of the neural network 114C. After the primary part 401C of the neural network 114C is frozen, the training device 308 trains the secondary party 401D of the neural network 114C, which includes training decoder channels 802 of the secondary part 401D of the neural network 114C together. The training device 308 may train the secondary part 401D of the neural network 114C using activations 412 of the primary part 401C of the neural network 114C. In this manner, the training device 308 trains multiple parts 401 of the composite neural network 114C to detect or recognize different primary segments of objects (e.g., upper bodies) or subsegments of objects (e.g., heads, eyes, etc.) that appear in an image.

The training device 308 receives a training image 314. The training image 314 may include primary segments of objects or subsegments of objects that the training device 308 will train the primary part 401C and the secondary part 401D of the neural network 114C to detect or recognize. The training image 314 may be accompanied by labeled data that indicates or identifies the primary segments of objects or subsegments of objects in the training image 314. The training device 308 may use the labeled data to verify predictions made about the training image 314.

The training device 308 passes the training image 314 to the primary part 401C of the neural network primary part 114C. The encoder 402D of the primary part 401C of the neural network 114C analyzes the training image 314 and generates the latent space 404D. The latent space 404D may be a representation or an embedding of the training image 314. In this manner, the encoder 402D converts the training image 314 from a pictorial representation to a different representation that may be analyzed by a machine. As more training images 314 are presented, the encoder 402D better learns the features or aspects in the training images 314 that may be indicative of a primary segment of objects (e.g., upper bodies) or subsegments of objects (e.g., heads, eyes, noses, etc.).

The training device 308 then trains the decoder 406D with multiple channels 802 of the primary part 401C of the neural network 114C together. In the example of FIG. 8, primary part 401C of the neural network primary part 114C includes decoder channels 802A, 802B, and 802C. The training device 308 trains the decoder channels 802A, 802B, and 802C together. Each decoder channel 802A, 802B, or 802C may be trained to analyze the latent space 404D and to detect or recognize a different primary segment of objects or different subsegments of objects in the training image 314 based on particular patterns or sequences in the latent space 404D. Because the training device 308 trains the channels 802A, 802B, and 802C together, detection of the primary segment objects and subsegments of objects are not learned independently, but are rather jointly learned. As a result, the decoder 406D with channels 802A, 802B, and 802C may learn relationships (e.g., contextual relationships and hierarchical relationships) between or amongst the different primary segments of objects and subsegments of objects, which may improve the accuracy of the neural network 114C in certain embodiments. For example, if the channel 802A is trained to detect or recognize the upper bodies of people and the channel 802B is trained to detect or recognize the heads of people, the channel 802B may further learn that if the channel 802A detects an upper body in an image then there is likely a head in the image near the top of the upper body.

As the channels 802A, 802B, and 802C are trained, the encoder 402D and the channels 802A, 802B, and 802C set weights 408D of the neural network 114C that are used to detect or recognize primary segments of objects or subsegments of objects in the training images 314. For example, if the decoder channels 802A, 802B, and 802C determine that a particular pattern or a sequence is indicative of a primary segment of objects or a subsegment of objects, the channels 802A, 802B, and 802C may set the weights 408D to emphasize the pattern or sequence when making predictions. On the other hand, if the decoder 406D on the channels 802A, 802B, and 802C determines that a particular pattern or sequence is not indicative of a particular primary segment of objects or subsegment of objects, then the decoder 406D may set the weights 408D to de-emphasize that pattern or sequence.

The training device 308 may test or verify the primary part 401C of the neural network 114C after the training process is complete. For example, the training device 308 may test the primary part 401C of the neural network 114C against a training image 314 so that the primary part 401C of the neural network 114C generates predictions 804 by applying the weights 408D to the training image 314. Specifically, the decoder 406D on the channels 802A, 802B, and 802C may generate predictions 804A, 804B, and 804C. For example, the decoder channel 802A may generate a prediction 804A for the locations of upper bodies in the training image 314. The decoder channel 802B may generate a prediction 804B for the location of heads in the training image 314. The decoder channel 802C may generate a prediction for the location of eyes in the training image 314. In some embodiments, the predictions 804 include heatmaps indicating the probability of certain portions of the training image 314 including a primary segment of objects or a subsegment of objects. The predictions 804 may indicate the predicted positions of primary segments of objects or subsegments of objects within the training image 314. The training device 308 may compare the predictions 804 with labeled data accompanying the training image 314 to determine an accuracy of the primary part 401C of the neural network 114C. If the accuracy meets a desired threshold, the training device 308 may consider the primary part 401C of the neural network 114C trained. If the accuracy does not meet the desired threshold, then the training device 308 may continue training the primary part 401C of the neural network 114C to improve its accuracy.

After the primary part 401C of the neural network 114C is trained, the training device 308 freezes the primary part 401C of the neural network 114C. To freeze the primary part 401C of the neural network 114C, the training device 308 freezes the weights 408D of the primary part 401C of the neural network 114C so that the weights 408D do not change during subsequent training steps.

The training device 308 then trains a secondary part 401D of the neural network 114C using information from the primary part 401C of the neural network 114C. For example, the training device 308 may provide the secondary part 401D of the neural network 114C with the activations 412 (e.g., partially or fully) of the primary party 401C of the neural network 114C, which may include the predictions 804A, 804B, and 804C. The training device 308 may also provide the training images 314 to the secondary part 401D of the neural network 114C. The training device 308 then trains the secondary part 401D of the neural network 114C to look within the primary segment of objects or subsegments of objects detected by the primary part 401C of the neural network 114C to detect or recognize other subsegments of objects or other features of subsegments of objects.

The encoder 402E of the secondary part 401D of the neural network 114C analyzes the activations 412 from the primary part 401C of the neural network 114C and generates the latent space 404E. The decoder 406E then analyzes the latent space 404E on channels 802D and 802E to generate predictions 804D and 804E. In some embodiments, the predictions 804D and 804E include heatmaps indicating the probability of certain portions of the training image 314 including subsegments of objects or features of subsegments of objects. The training device 308 may train the decoder 406E with channels 802D and 802E together to detect subsegments of objects or features of subsegments of objects that appear within the primary segments of objects or subsegments of objects detected by the primary part 401C of the neural network 114C. For example, the training device 308 may train the decoder channel 802D to detect noses that appear within the heads detected by the decoder 406D on channel 802B and the decoder 406E on channel 802E to detect fingers that appear on the arms detected by the decoder 406D on channel 802C. As another example, the training device 308 may train the decoder channel 802E to detect an orientation of the heads detected by the decoder 406D on channel 802B. Because the decoder channels 802D and 802E are trained together, the secondary part 401D of the neural network 114C may learn the relationships (e.g., contextual relationships and hierarchical relationships) between the subsegments of objects or features of the subsegments of objects that the decoder 406E with channels 802D and 802E are trained to detect, which may improve the accuracy of the secondary part 401D of the neural network 114C.

As the decoder 406E with channels 802D and 802E is trained, the encoder 402E and the channels 802D and 802E set weights 408E of the secondary part 401D of the neural network 114C that are used to detect or recognize the subsegments of objects in the training images 314. For example, if the decoder 406E with channels 802D and 802E determines that a particular pattern or a sequence is indicative of subsegments of objects or features of subsegments of objects, the weights 408E may be set to emphasize the pattern or sequence when making predictions. On the other hand, if the decoder 406E on channels 802D and 802E determines that a particular pattern or sequence is not indicative of particular subsegments of objects or features of subsegments of objects, then the weights 408E may be set to de-emphasize that pattern or sequence.

After the secondary part 401D of the neural network 114C is trained, the training device 308 may test or verify the secondary part 401D of the neural network 114C. The training device 308 may use the secondary part 401D of the neural network 114C to detect subsegments of objects or features of subsegments of objects in a training image 314 using the predictions 804A, 804B, and 804C from the primary part 401C of the neural network 114C. The training device 308 compares the predictions 804D and 804E with labeled data accompanying the training image 314 to determine an accuracy of the secondary part 401D of the neural network 114C. If the accuracy meets a desired threshold, the training device 308 may consider the secondary part 401D of the neural network 114C trained. If the accuracy does not meet the desired threshold, then the training device may continue training the secondary part 401D of the neural network 114C to improve its accuracy.

In this manner, the training device 308 trains the decoders 406D and 406E with multiple channels 802 of the primary part 401C and the secondary part 401D of the neural network 114C to detect different segments of objects and subsegments of objects in images. As a result, the primary part 401C and the secondary part 401D of the neural network 114C may be used to detect or recognize multiple segments of objects and multiple subsegments of objects in images. In some embodiments, because the secondary part 401D of the neural network 114C is trained using information from the primary part 401C of the neural network 114C, the secondary part 401D of the neural network 114C is smaller in size compared to a individual neural network that was independently trained to recognize the subsegments of objects or features of subsegments of objects in the training images 314. As a result, it may take less computing resources to store and apply the composite neural network 114C with primary part 401C and secondary part 401D than two independently trained neural networks, which may allow certain computing systems with limited computing resources to use single composite neural network with individually trained parts and shared activations.

FIG. 9 is a flowchart of an example method 900 for training a composite neural network performed in the system 300 of FIG. 3. In particular embodiments, the training device 308 performs the method 900. By performing the method 900, the training device 308 trains the primary part 401C and the secondary part 401D of the composite neural network 114C to detect or recognize multiple primary segments of objects and subsegments of objects (or features of subsegments of objects) in images.

In block 902, the training device 308 receives a training image 314. The training image 314 may include primary segments of objects and subsegments of objects that the training device 308 may train the neural network 114C to detect or recognize. The training image 314 may be accompanied by labeled data that indicates or identifies the primary segments of objects or subsegments of objects in the training image 314.

In block 904, the training device 308 trains a first decoder 406D with channel 802A of the primary part 401C of the neural network part 114C. The training device 308 may train the first channel 802A to detect a primary segment of objects in the training image 314. For example, the training device 308 may train the first channel 802A to recognize upper bodies of people appearing in images.

While the decoder 406D with first channel 802A is being trained, the training device 308 also trains the decoder 406D on a second channel 802B of the primary part 401C of the neural network 114C in block 906. The training device 308 may train the decoder 406D with the second channel 802B to detect a primary segment of objects or a subsegment of objects. For example, the training device 308 may train the decoder 406D on the second channel 802B to detect or recognize the heads of people in the training image 314. The heads of the people may be part of the upper bodies of the people that the first channel 802A is being trained to detect or recognize. By training the decoder 406D on the second channel 802B together with the first channel 802A, the training device 308 may train the primary part 401C of the neural network 114C to learn relationships between the primary segment of objects and subsegments of objects. For example, the primary part 401C of the neural network 114C may learn that the heads of people appear near the top of the upper bodies of the people.

In block 908, the training device 308 freezes the primary part 401C of the neural network 114C. The training device 308 may freeze the primary part 401C of the neural network 114C after the training device 308 considers the primary part 401C of the neural network 114C trained. For example, the training device 308 may consider the primary part 401C of the neural network 114C trained when an accuracy of the primary part 401C of the neural network 114C meets a desired threshold. The training device 308 may freeze the weights 408D of the primary part 401C of the neural network 114C so that the weights 408D do not change during subsequent steps of the method 900.

In block 910, the training device 308 trains a third channel 802D of a secondary part 401D of the neural network 114C. The training device 308 may train the third channel 802D using information from primary part 401C of the neural network 114C. For example, the training device 308 may provide the activations 412 of the primary part 401C of the neural network 114C to the secondary part 401D of the neural network 114C. The training device 308 may train the third channel 802D to detect or recognize a subsegment of object that appears within a primary segment of objects or a subsegment of object detected by the primary part 401C of the neural network 114C. For example, the training device 308 may train the third channel 802D to detect or recognize the noses of people in the training image 314.

While the training device 308 is training the third channel 802D, the training device 308 may also train a fourth channel 802E of the secondary part 401D of the neural network 114C in block 912. The training device 308 may train the fourth channel 802E to detect or recognize another subsegment of object in the training image 314. For example, the training device 308 may train the fourth channel 802E to detect or recognize the mouths of people in the training image 314. By training the third channel 802D and the fourth channel 802E together, the secondary part 401D of the neural network 114C may learn relationships (e.g., contextual relationships and hierarchical relationships) between the subsegments of objects detected by the third channel 802D and the fourth channel 802E. For example, the secondary part 401D of the neural network 114C may learn that the noses of people appear within heads.

In summary, a training device 308 may use various processes for training a neural network 114 to detect both a primary segment of objects (e.g., upper bodies) in an image and a subsegment of objects (e.g., heads) within the primary segment of objects (or features of the subsegment of objects). In a first process (which may be referred to as tailing), a primary part 401A of a neural network 114A is trained to detect the primary segment of objects. The primary part 401A of the neural network 114A is then frozen and its activations 412 are used to train a secondary part 401B of the neural network 114A to detect the subsegment of objects or a feature of the subsegment of objects. Because secondary part 401B of the neural network 114A has the benefit of the knowledge learned by the primary part 401A of the neural network 114A (specifically, the localizations of the primary segment of objects in images) and because the secondary part 401B of the neural network 114A understands that the subsegment of objects appears in the primary segment of objects, the secondary part 401B of the neural network 114A is generally smaller in size than a neural network that was independently or separately trained to recognize the subsegment of objects and more accurate having hierarchical/pyramidal object segmentation. As a result, the first training process trains multiple parts of a composite neural network 114 with a smaller combined size and higher accuracy than if the multiple neural networks were trained independently or separately.

In a second process (which may be referred to as channeling), multiple channels 602 of a decoder 406C of a neural network 114B are trained together to detect the primary segment of objects and the subsegment of objects. For example, a first channel 602A may be trained to recognize the primary segment of objects. While that first channel 602A is being trained, a second channel 602B is trained to detect the subsegment of objects or a feature of the subsegment of objects. Any suitable number of channels 602 may be trained to detect any suitable number of primary segments or subsegments of objects. As a result, a single neural network 1146 with multiple channels is trained to recognize both a primary segment objects and a subsegment of objects.

In a third process, multiple channels 802 of a decoder 406D of a primary part 401C of a neural network 114C are trained together to detect different primary segments or subsegments of objects. The primary part 401C of the neural network 114C is then frozen and its activations 412 are used to train multiple channels 802 of a decoder 406E of a secondary part 401D of the neural network 114C together to detect different subsegments of objects within the primary segments or subsegments of objects detected by the primary part 401C of the neural network 114C. As a result, the third training process produces composite neural networks 114 with multiple channels 802 that detect different primary segments and subsegments of objects.

The methods, systems, and devices described herein collectively can be useful for analyzing portions of various video generating applications, which can include video conferencing, live streaming or other similar video generating activities. As discussed herein the methods, systems, and devices described herein can be used to improve the analysis of an activity and attributes of one or more objects within a video generating application, such as the users during a video conference. In one example, the methods, systems, and devices described herein can collectively provide a single or a multi-camera video conferencing system and video conferencing method that allows each individual speaker to be detected regardless of their seating or speaking position, which can allow one or more algorithms running within the video conferencing system to utilize information collected about one or more of the detected speakers to be used to further one or more aspects of the video conferencing activity and experience. In one example, the various processes for training a machine learning model to detect both a segments of objects (e.g., upper bodies) in an image and a subsegment of objects (e.g., heads) within the primary segment of objects can be used to help track the movement or position of a current speaker to determine who is currently speaking or that the head of the current speaker is turned and that another camera may be better suited to be the visual data source for the current speaker. In another example, in some video conferences, by use of the machine learning model(s) and results obtained therefrom, it may be desirable to keep a view on a particular key participant in the local environment, such as an important client attending the conference, main presenter, or guest speaker. In yet another example, the various processes for training a machine learning model to detect both primary segments of objects and subsegments of objects, primary segments of objects in an image and subsegments of objects within the primary segments of objects can be used to perform facial recognition and/or in some cases additionally collect relevant data being provided by the important participant.

While the foregoing is directed to embodiments of the present disclosure, other and further embodiments of the disclosure may be devised without departing from the basic scope thereof, and the scope thereof is determined by the claims that follow.

What is claimed is:

1. A method of training a machine learning model, the method comprising:
training a primary part of a composite neural network to identify a primary segment of objects in a training image;
freezing the primary part of the composite neural network after training the primary part of the composite neural network; and
after freezing the primary part of the composite neural network, training, using activations of the primary part of the composite neural network, a secondary part of the composite neural network to identify a first subsegment of objects or a feature of the first subsegment of objects in the training image, wherein the first subsegment of objects is a subset of the primary segment of objects.

2. The method of claim 1, wherein the primary segment of objects comprises portions of objects appearing in the training image, and wherein the first subsegment of objects comprises sub-portions of the portions of the objects appearing in the training image.

3. The method of claim 2, wherein the primary segment of objects comprises upper bodies of people appearing in the training image, and wherein the first subsegment of objects comprises heads of the people appearing in the training image.

4. The method of claim 1, further comprising converting, using an encoder of the primary part of the composite neural network, the training image into a latent space, wherein a decoder of the primary part of the composite neural network is trained using the latent space.

5. The method of claim 1, wherein training the primary part of the composite neural network sets a plurality of weights of the primary part of the composite neural network, and wherein freezing the primary part of the composite neural network comprises freezing the plurality of weights of the primary part of the composite neural network.

6. The method of claim 1, wherein an activation of the primary part of the composite neural network comprises a heatmap indicating probabilities where the primary segment of objects appear at locations in the training image.

7. The method of claim 1, wherein each object of the first subsegment of objects is contained within the primary segment of objects.

8. The method of claim 1, wherein training the secondary part of the composite neural network is further based on the training image.

9. The method of claim 1, further comprising:
freezing the secondary part of the composite neural network after training the secondary part of the composite neural network; and
after freezing the secondary part of the composite neural network, training, using activations of the secondary part of the composite neural network, a tertiary part of the composite neural network to identify a second subsegment of objects or a feature of the second subsegment of objects in the training image, wherein the second subsegment of objects is a subset of the subsegment of objects.

10. The method of claim 9, further comprising:
freezing the tertiary part of the composite neural network after training the tertiary part of the composite neural network; and
after freezing the tertiary part of the composite neural network, training, using activations of the secondary part of the composite neural network, a quaternary part of the composite neural network to identify a third subsegment of objects or a feature of the third subsegment of objects in the training image, wherein the third subsegment of objects is a subset of the subsegment of objects.

11. A method of training a machine learning model, the method comprising:
training a first channel of a neural network to identify a primary segment of objects in a training image; and
while training the first channel, training, using the training image, a second channel of the neural network to identify a subsegment of objects or a feature of the subsegment of objects in the training image, wherein the subsegment of objects is a subset of the primary segment of objects.

12. The method of claim 11, wherein the primary segment of objects comprises portions of objects appearing in the training image, and wherein the subsegment of objects comprises sub-portions of the portions of the objects appearing in the training image.

13. The method of claim 12, wherein the primary segment of objects comprises upper bodies of people appearing in the training image, and wherein the subsegment of objects comprises heads of the people appearing in the training image.

14. The method of claim 11, further comprising converting, using an encoder of the neural network, the training image into a latent space, wherein the first channel and the second channel are trained using the latent space.

15. A method of training a machine learning model, the method comprising:
training a first channel of a primary part of a composite neural network to identify a primary segment of objects in a training image;
while training the first channel of the primary part of the composite neural network, training, using the training image, a second channel of the primary part of the composite neural network to identify a first subsegment of objects in the training image, wherein the first subsegment of objects is a subset of the primary segment of objects;
freezing the primary part of the composite neural network after training the first channel and the second channel of the primary part of the composite neural network; and
after freezing the primary part of the composite neural network, training, using the training image and activations of the primary part of the composite neural network, a third channel of a secondary part of the composite neural network to identify a second subsegment of objects or a feature of the second subsegment of objects in the training image, wherein the second subsegment of objects is a subset of the first subsegment of objects.

16. The method of claim 15, wherein the primary segment of objects comprises portions of objects appearing in the training image, and wherein the first subsegment of objects comprises sub-portions of the portions of the objects appearing in the training image.

17. The method of claim 16, wherein the primary segment of objects comprises upper bodies of people appearing in the training image, and wherein the first subsegment of objects comprises heads of the people appearing in the training image.

18. The method of claim 15, further comprising converting, using an encoder of the primary part of the composite neural network, the training image into a latent space, wherein the first channel and the second channel are trained using the latent space.

19. The method of claim 15, wherein training the first channel and the second channel of the primary part of the composite neural network sets a plurality of weights of the primary part of the composite neural network, and wherein freezing the primary part of the composite neural network comprises freezing the plurality of weights of the primary part of the composite neural network.

20. The method of claim 15, wherein an activation of the primary part of the composite neural network is a heatmap indicating probabilities where the primary segment of objects and the first subsegment of objects appear at locations in the training image.
